(19) United States
(12) Patent Application Publication
(10) Pub. No.: US 2005/0271973 A1
(43) Pub. Date: Dec. 8, 2005

(54) Negative acting photoresist with improved blocking resistance

(76) Inventors: Michael J. Ziegler, Cranberry Twp., PA (US); Randal L. Campbell, New Alexandria, PA (US); Kevin C. Olson, Wexford, PA (US)

Correspondence Address: PPG Industries, Inc.;Intellectual Property Department, One PPG Place, Pittsburgh, PA, 15272, US

(21) Appl. No.: 10/861,051

(22) Filed: Jun. 4, 2004

(51) Int. Cl. G03C 1/492

(52) U.S. Cl. 430/270.1

(57) ABSTRACT

Novel compositions comprising photoactive urethane acrylate resins and an ethylenically unsaturated reactive diluent are disclosed. The urethane acrylate resin comprises the reaction product of a polyhydric acrylate monomer and an isocyanurate. The compositions find particular application in negative photoresist compositions and exhibit improved blocking resistance compared with other negative photoresist compositions. Methods for using the compositions are also disclosed.

### BACKGROUND OF THE INVENTION

1. Field of the Invention

The present invention relates generally to negative photoresist compositions that have enhanced blocking resistance. More specifically, the compositions comprise a mixture of a urethane acrylate resin and an ethylenically unsaturated reactive diluent.

2. Field of the Invention

Processes for forming resist patterns on the surfaces of substrates typically comprise forming a photo-sensitive layer on the surface of the substrate with a photoresist composition, irradiating portions of the photo-sensitive layer with actinic light and developing the irradiated layer. If the solubilizatibn of the photoresist increases when exposed to actinic light, it is referred to as a “positive-acting” photoresist; the relatively high molecular weight positive-acting photoresist material depolymerizes, or undergoes breakage of the polymer bonds, upon exposure to actinic radiation thereby rendering the treated compound more easily dissolved by a developing solution. If the solubilization of the photoresist decreases when exposed to actinic radiation, it is referred to as a “negative-acting” photoresist; the relatively low molecular weight negative-acting material crosslinks upon exposure to actinic radiation and, thus, it is the non-treated compound that dissolves upon exposure to the developing solution.

Photoresists are often Used to protect the underlying substrate from the effects of a subsequent etching process. Following etching, the photoresist is stripped from the substrate to yield a completed product. Defects in the resist pattern, such as inadequate coverage over certain parts of the substrate or inadequate development of the irradiated layer, can result in problems in the completed product. Accordingly, it is important to employ a photoresist whose irradiated layer can adequately be developed and that forms a uniform layer over all surfaces of the substrate to be protected.

Photoreactive polymers are particularly useful as binder resins in photoresist compositions employed in photodevelopment of electronic components such as circuit boards and other products.

A negative photoresist is a relatively low molecular weight composition, such as a polymer, that polymerizes upon exposure to actinic radiation, thereby increasing the overall molecular weight of the composition. The negative photoresist composition that is exposed to actinic radiation is not dissolved by a developing solution, whereas the portion of the composition that has not been exposed to actinic radiation is removed. Negative-acting photoresists are often preferred in certain applications, such as in the manufacture of circuit boards.

The surface characteristics of positive photoresists are often superior to negative photoresists, with fewer mechanical defects. In addition, positive-acting photoresists often handle better than their negative counterparts. Thus, positive photoresists are often of higher molecular weight, which yields more robust films that are less “sticky” or susceptible to marring than negative photoresists. The energy needed to form bonds or promote crosslinking in the case of negative photoresists, however, is typically much lower than the energy needed to break bonds in the case of positive photoresists. In addition, positive photoresists can often have a longer processing time than negative photoresists.

Accordingly, negative photoresists that form robust films with good blocking resistance and/or mar resistance are desired.

### SUMMARY OF THE INVENTION

The present invention provides negative photoresist compositions comprising a urethane acrylate resin with sufficient acid functionality to solubilize the compositions in an alkaline developing solution, an ethylenically unsaturated reactive diluent and a photoinitiator. The resin may include a reaction product of a polyhydric acrylate monomer and a trimer of a polyisocyanate. Methods for improving blocking resistance using these compositions are also within the scope of the present invention.

The present invention provides negative photoresists that have enhanced blocking resistance. “Blocking resistance” and like terms refer to the resistance of layers of the photoresist to adhere to one another when substrates bearing the photoresists are stacked. Thus, the present invention provides for a negative photoresist with enhanced blocking resistance and resistance to marring. Although not wishing to be bound by this mechanism, it is believed that the present compositions achieve enhanced blocking resistance through the use of a branched urethane acrylate resin with relatively high molecular weight in combination with an ethylenically unsaturated reactive diluent and a photoinitiator.

### DETAILED DESCRIPTION OF THE INVENTION

The present invention is directed to compositions comprising a urethane acrylate resin, which is a photoactive polymer, a reactive diluent, and a photoinitiator. The compositions find particular application as negative photoresists.

The urethane acrylate resin has sufficient acid functionality to solubilize the unexposed composition in an aqueous alkaline developing solution; “unexposed composition” refers to that portion of the composition that is not exposed to actinic radiation. Typically, the acid number of the polymer will be at least 40 mg KOH/gram or at least 60 mg KOH/gram. It will be understood that if the polymer is dissolved in solution, the acid number will decrease. The weight average molecular weight for the resin is typically about 8,000 to 36,000 or about 13,000. In one embodiment, the urethane acrylate resin includes sufficient cyclic groups (aliphatic, aromatic or both) for providing rigidity to the resin. Cyclic groups can be incorporated into the urethane acrylate polymer through any of the monomer(s) used in formation of the polymer.

The urethane acrylate resin includes a reaction product of a polyhydric acrylate monomer and an isocyanurate. The term “isocyanurate” is used herein and will be understood by those skilled in the art as referring to a cyclic trimer of polyisocyanate. The polyhydric acrylate monomer typically includes at least two hydroxyl groups for building the urethane resin and at least two acrylic groups that serve to crosslink upon exposure to actinic radiation. Suitable polyhydric acrylates are compounds based on bisphenol-A, such as bisphenol-A epoxy diacrylate, which provides hydroxyl functionality and ring structures for rigidity.

Isocyanurates particularly useful in the present invention are based on cycloaliphatic or aromatic polyisocyanates. As noted above, use of cyclic groups can contribute to the rigidity of the urethane acrylate resin. Suitable cycloaliphatic diisocyanates include isophorone diisocyanate (IPDI), 1,3- or 1,4-cyclohexane diisocyanate, dicyclohexylmethane diisocyanate, as well as their corresponding isomer mixtures and the like. Aromatic isocyanates that may be used include tetraalkylxylene diisocyanates such as m-tetramethyl xylene diisocyanate (m-TMXDI), p-phenylene diisocyanate, polymethylene polyphenyl isocyanate, 2,6-toluene diisocyanate, dianisidine diisocyanate, bitolylene diisocyanate, naphthalene- 1,4-diisocyanate, bis(4-isocyanato phenyl)methane, and 4,4′-diphenylpropane diisocyanate. These isocyanates can be used alone or in combination. Noncyclic isocyanates can also be used to form the isocyanurate, such as hexamethylene diisocyanate.

Additional polyhydric monomers and polyisocyanate monomers may be included in the reaction product that is the urethane acrylate resin of the present invention, to build molecular weight. Suitable polyhydric monomers may include an acid group such as dimethylpropionic acid. Diisocyanate monomers particularly useful for extending the molecular weight of the acrylate urethane resin can be cyclic and may include the diisocyanates described above in reference to the isocyanurate with m-TMXDI being particularly useful. Ethoxylated polyols having functional groups that serve to solubilize the composition in a developing solution may also be included. Suitable polyols include polyethylene glycol, polypropylene glycol or any other hydroxyl functional polyether with a particularly suitable polyether being a bisphenol-A polyether such as that of Formula I:
O—CH₂—CH₂ (O—CH₂—CH₂)ₘ—O—R—O—(CH₂—CH₂—O)ₙ—CH₂—CH₂—O I
where m+n=9; and
R is

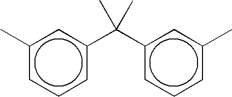

The reaction to produce the urethane acrylate resin is performed in an alkaline aqueous solution such as a propylene glycol monoalkyl ether acetate such as propylene glycol monomethyl ether acetate with a catalyst such as a tin catalyst. The reaction may also be controlled through additions of an ethylenically unsaturated monohydric monomer such as a hydroxy alkyl acrylate, e.g. hydroxy ethyl acrylate. The hydroxyl group serves to bind with any free isocyanate groups remaining on the urethane polymer to control molecular weight growth. The unsaturation of the monohydric monomer provides additional crosslinking sites.

Other components may be included in the urethane reaction mixture that may or may not become incorporated in the urethane acrylate resin such as a free-radical cure inhibitor (e.g., a hydroquinone) and a monohydric alcohol (such as tridecyl alcohol) added at or near the completion of the urethane reaction to bind any remaining isocyanate groups in solution. Some of the monohydric alcohol may remain in solution and may serve to act as a surfactant. The urethane acrylate resin can be produced in a solvent, typically at about 50 percent solids. The relatively low solids content serves to ensure solubilization, control viscosity and act as a heat sink for energy released in the isocyanate/alcohol reaction.

The reactive diluent used in the compositions of the present invention is a monomer or oligomer having ethylenic unsaturation. Particularly suitable are reactive diluents having multiple points of ethylenic unsaturation and relatively low molecular weight (i.e. 1000to 2000). Such diluents contribute to a high crosslink density of the film that results upon curing of the present compositions. Examples include, but are not limited to, polyfunctional reactive diluents such as trimethylolpropane tri(meth)acrylate, glycerol triacrylate, pentaerythritol triacrylate, pentaerythritol tetraacrylate, di-trimethyl propane tetraacrylate, or dipentaerythritol pentaacrylate (DPETA).

The reactive diluent reacts with the urethane acrylate resin upon curing of the present compositions by exposure to actinic radiation in the presence of a photoinitiator such as benzophenones, acetophenone derivatives, such as alpha-hydroxyalkylphenylketones, benzoins such as benzoin alkyl ethers and benzyl ketals, monoacylphosphine oxides, and bisacylphosphine oxides. The present compositions may be solvent borne, water borne or may be produced in bulk and may further include conventional additives known in the art such as colorants, surfactants, fillers and the like.

The photoresist composition of the present invention typically includes about 50 to 80 wt. % urethane acrylate resin, 15 to 30 wt. % reactive diluent and about 5 to 15 wt. % photoinitiator. Other additives, if used, can comprise up to about 20 wt. % of the present compositions. Additives may include dyes, pigments, surfactants or other conventional additives. The surfactants, may be cationic surfactants, anionic surfactants, amphoteric surfactants, nonionic surfactants and mixtures thereof. The reactive diluent, photoinitiator and any additives are mixed into the urethane acrylate resin composition to produce a photoresist composition and are stored in a light-proof container until use.

The present invention is further directed to a method for improving blocking resistance in a negative photoresist by using the compositions of the present invention. The photoresist can be applied to any suitable substrate. Examples include wood, paper, particle board, chipboard, metals, metals having primers, glass, plastics, and metallized plastics. The coated substrates have a variety of applications, such as in the chemical milling industry, lead frame manufacturing, manufacture of aperture screens, the printing plate industry and especially the circuit board industry. The photoresist can be applied to the substrate by any known means, such as brushing, dipping, roll coating, doctor blade coating, spraying, curtain coating, and electrodeposition. Such methods are standard practice in the various arts in which the photoresists find application.

Following application of a photoresist, the substrate comprising the photoresist, which can be on either or both sides, is typically placed beneath a mask either on one or both sides. The mask will typically be a material through which actinic radiation will pass, such as Mylar, glass, quartz and the like, to which is applied a pattern through which actinic radiation will not pass. Often, a vacuum will be applied to draw the mask or masks into intimate contact with the photoresist. The photoresist is then treated with actinic radiation, such as from a UV lamp, at a dosage sufficient to effect the treatment of the photoresist. “Treatment” and like terms refer to exposure to actinic radiation so as to effect polymerization of the photoresist material, which decreases solubilization of the photoresist.

After irradiation and removal of the photomask, the photoresist film is developed. Development of the photoresist film entails subjecting it to a developing solution by spraying, dipping, or the like. A suitable developing solution used for polymeric materials is an alkaline, aqueous solution, such as KOH, NaOH, K₂CO₃ or Na₂CO₃ solutions. The developing solution forms salt with unreacted carboxylic acid groups of the urethane acrylate resin on the unexposed photoresist, which has not increased in molecular weight. The low molecular weight of unexposed photoresist combined with the acid functionality renders the unexposed photoresist soluble and removable. The time required in the developing solution to remove the solubilizable photoresist is referred to as the clear time.

Usually, the photoresist film is developed at a temperature between about room temperature and 180° F. over a period of between about 10 seconds and 10 minutes. The concentration of the base in the developing solution can be between about 0.05 and 20 weight percent in water. The unexposed areas of a negative photoresist remain soluble in the developing solution while the increased molecular weight of the exposed areas causes these areas to become significantly less soluble in a developing solution. Thus, there is a solubility differential between the exposed and unexposed areas of the photoresist film, and the developing solution removes the unexposed areas. It is typically desired that this difference in solubility be great enough that contact of the exposed photoresist to the developing solution does not result in appreciable loss of film in the areas where it is desired for the film to remain, i.e. the exposed areas. Less than 10 percent loss of exposed photoresist following four times the clear time in the developing solution is typically desired and is achieved by the present compositions.

Because different radiometers can give very divergent dosage readings, the circuit board industry has established the Stouffer Step Tablet (“SST”) for standardization purposes. SST is a 21-step gray scale that will provide image quality results that can be compared regardless of the developer used, the radiometer used, etc. For negative photoresists, a solid step value of about 4 to 8 is typically desired and achieved by the present compositions.

As used herein, unless otherwise expressly specified all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Accordingly, it should be understood that mixtures of photoactive polymers and/or mixtures of photoacid generators, as well as mixtures of any other components described herein, are within the scope of the present invention. Also, as used herein, the term “polymer” is meant to refer to oligomers and both homopolymers and copolymers; the prefix “poly” refers to two or more.

### EXAMPLES

### Example 1

### Preparation of Urethane Acrylate Resin

To an appropriately sized reaction vessel, equipped with a mechanical stirrer, nitrogen inlet tube, thermometer and a condenser, was added 650.0 parts by weight (pbw) EBECRYL 3700, 756.0 pbw dimethylol propionic acid, 7.4 pbw 2-methyl hydroquinone, and 1132.4 pbw propylene glycol methyl ether acetate. This mixture was agitated at 300 RPM and heated to 80° C. under a nitrogen atmosphere. Once the reaction mixture was at temperature, 10.29 pbw dibutyltin dilaurate was added to the reaction vessel, immediately followed by addition of 1996.3 pbw m-tetramethyl xylene diisocyanate over 60 minutes. After this addition was completed, 250 pbw propylene glycol methyl ether acetate was added and the reaction mixture was held for an additional 60 minutes at 80° C. After the completion of the hold time, 722.8 pbw VESTANAT T-1890, 155.6 pbw MACOL 98B, 510.7 pbw EBECRYL 3700, and 848.0 pbw propylene glycol methyl ether acetate were added to the reaction vessel. EBECRYL 3700 is the acrylate ester of an epoxy resin commercially available from UCB Chemical. VESTANAT T-1890 is the isocyanurate trimer of isophorone diisocyanate supplied at 70 percent solids in n-butyl acetate by Degussa CRM. MACOL 98B is an ethoxylated bisphenol-A polyol commercially available from BASF.

The reaction mixture was held at temperature until the reaction mixture was found to have an isocyanate equivalent weight greater than 2,200 grams/equivalent, at which time 289.2 pbw 2-hydroexthyl acrylate and 955.9 pbw propylene glycol methyl ether acetate were added to the reaction vessel. The reaction mixture was held at 80° C. for an additional 60 minutes, after which time 38.2 pbw of tridecyl alcohol and 1715.7 pbw propylene glycol methyl ether acetate were added to the reaction vessel. The reaction mixture was then held at 80° C. until infrared spectroscopy indicated that all of the isocyanate groups had been consumed.

The reaction product was then cooled, discharged and determined to have a solids content of 50.1 wt. %, acid content of 0.536 milli-equivalents/gram, and a density of 8.93 pounds/gallon. Analysis of the resin solution by gas phase chromatography. (using linear polystyrene standards) showed the polymer to have an M_{w}, value of 15,925, Mₙ value of 2,466, and an M_{w}/Mₙ value of 6.5. The reaction product was used directly in Example 2.

### Example 2

### Preparation of Negative Photoresist Composition

A negative photoresist composition was formulated using the components in the amounts shown in Table 1. All of the components were added to a mixing vessel and stirred using a Cowles blade at a slow setting for 10 minutes. The formulated product was then filtered through a double paper cone.

TABLE 1

| Component | Weight % |
|---|---|
| Resin from Example 1 | 62.72 |
| Dowanol PMA¹ | 20.09 |
| Solvent Blue 36² | 0.12 |
| DAROCUR 4265³ | 4.32 |
| DiPeta⁴ | 11.52 |
| BYK 354⁵ | 0.75 |
| SURFYNOL 104E⁶ | 0.48 |
| Total | 100.00 |

¹Propylene glycol methylether acetate supplied by Dow Chemical of Midland, Michigan.
²Solvent Blue is an oil blue dye supplied by The Color and Chemical Co. of Passaic, New Jersey.
³Photoinitiator supplied by Ciba Specialty Chemicals of Tarrytown, New York.
⁴Dipentaerythritol pentaacrylate supplied by Sartomer Co., Inc. of Exton, Pennsylvania.
⁵Surfactant supplied by BYK-Chemie USA Inc. of Wallington, Connecticut.
⁶Surfactant supplied by Air Products and Chemicals, Inc. of Allentown, Pennsylvania.

The formulation was found to have a density of 8.88 pounds/gallon and an efflux time of 42-43 seconds as measured using a Zahn #4 cup. The non-volatile content was found to be 43.7 percent after baking a sample at 150° C. for 1 hour.

Photoresist samples were prepared.on Nelco single-sided ½ oz. 10 mil core copper panels using a drawdown bar to achieve a dry film thickness of 0.22 mils. The wet photoresist coated panels were dried at various temperatures for 6 minutes. The panels were then exposed though a Conductor Analysis Test (CAT) pattern Mylar mask and a Stouffer 21 Step Tablet at an exposure energy setting of 160 mJ/cm² (as measured with APM model 87 radiometer with standard 320-380 nm probe). A 1.0% w/w potassium carbonate developer at 95° F. was used to target a solid step of 3-7. The properties of the coated panels are listed in Table 2.

TABLE 2

| | Sample | Sample | Sample | Sample |
|---|---|---|---|---|
| | 1 | 2 | 3 | 4 |
| Drying temperature (° C.) | 125 | 115 | 105 | 95 |
| Clear time (sec.) | 16 | 16 | 17 | 18 |
| Develop Time (sec.) | 32 | 32 | 34 | 36 |
| Stouffer Step Tablet | Solid 7 | Solid 7 | Solid 7 | Solid 7 |
| 4× Exposed Film | 5.48% | 7.04% | 7.73% | 5.34% |
| Loss test | | | | |
| 2 min. Exposed Film | 8.85% | 8.76% | 7.69% | 10.17% |
| Loss Test | | | | |
| CAT pattern reproduction | | | | |
| Mid-space 1.458 | 1.197 | 1.010 | 1.234 | 1.084 |
| Line 0.748 | 0.972 | 1.197 | 1.010 | 1.047 |
| Space 0.935 | .710 | 0.524 | 0.748 | 0.710 |
| Line 1.271 | 1.496 | 1.654 | 1.496 | 1.533 |
| Space 1.496 | 1.234 | 1.122 | 1.122 | 1.122 |
| Line 1.720 | 2.019 | 2.094 | 2.019 | 2.057 |
| Space 1.944 | 1.720 | 1.608 | 1.757 | 1.720 |
| Line 2.281 | 2.431 | 2.580 | 2.505 | 2.468 |

The clear time is the length of time required to completely remove the unexposed photoresist with the developer. A portion of the panel is masked off, the panel is exposed to light and developed to remove the unexposed resist. The end point of complete removal is determined visually upon observing the copper substrate where the unexposed photoresist is removed. Develop time is calculated as two times the clear time.

In the Stouffer Step Tablet test, the panel exposed through the step tablet is developed at two times the clear time in either a spray or dip developer. The step tablet has 21 numbered areas. The highest number with photoresist remaining is recorded for a negative acting photoresist.

For a negative acting photoresist, 4× Exposed Film Loss (4×EFL) is the percentage of the overall coating weight of photoresist that is removed from a coated, exposed panel that has been developed at four times the required clear time once referred to as four times exposed film loss (4×EFL). The loss of exposed film after two minutes in the developer as a percentage of the overall coating weight is reported in the 2 Minutes Exposed Film Loss test. The CAT test measures artwork lines and spaces on a Mylar mask to show the extent to which the photoresist of the present invention is able to reproduce the artwork of the Mylar mask. The line and space widths were measured using a Nikon Eclipse ME600 microscope. As shown in Table 2, the width of the lines and spaces after development closely match the line and space width of the mask artwork.

Table 3 shows the results of the block test from samples prepared using production equipment. Nelco ½ oz. double-sided 10 mil core panels coated with the photoresist at a film thickness of 0.2 mils were placed in intimate contact with each other with the coated sides facing each other. Uniformly distributed weights of 0.01 and 0.20 psi were applied. These tests were done using a collection tote at the end of a production line and on a flat surface. The panels were prepared on a Burkle roll coater equipped with 72 TPI rolls cut with a 90° V cut from Wagner Rubber.

TABLE 3

| | Blocking |
|---|---|
| Tote test | All Pass |
| Flat surface | All Pass |

The term “All Pass” indicates that there was no transfer of film between the, panel, and that none of the panels stuck together.

Whereas particular embodiments of this invention have been described above for purposes of illustration, it will be evident to those skilled in the art that numerous variations of the details of the present invention may be made without departing from the invention as defined in the appended claims.

1. A photoresist composition comprising:
a) a urethane acrylate resin having acid functionality sufficient to solubilize said photoresist composition in an alkaline developing solution;
b) an ethylenically unsaturated reactive diluent; and
c) a photoinitiator, said resin comprising the reaction product of a polyhydric acrylate monomer and an isocyanurate of a polyisocyanate.

2. The composition of claim 1, wherein the isocyanurate is formed from a cycloaliphatic and/or aromatic polyisocyanate.

3. The composition of claim 2, wherein said isocyanurate comprises a trimer of a polyisocyanate selected from the group consisting of isophorone, cyclohexanediisocyanate, dicyclohexylmethane diisocyanate, tetralkyl xylene diisocyanate, p-phenylene diisocyanate, polymethylene polyphenyl-isocyanate, 2,6-toluene diisocyanate, dianisidine diisocyanate, bitolylene diisocyanate, naphthalene-1,4-diisocyanate, bis(4-isocyanato phenyl)methane, and 4,4′-diphenylpropane diisocyanate.

4. The composition of claim 1, wherein said isocyanurate is an isocyanurate of isophorone diisocyanate.

5. The composition of claim 1, wherein said polyhydric acrylate monomer comprises the reaction product of a bisphenol A diglycidyl ether with an acrylic acid.

6. The composition of claim 5, wherein said polyhydric acrylate monomer comprises bisphenol-A-epoxy diacrylate.

7. The composition of claim 5, wherein said polyhydric acrylate monomer further comprises a dihydroxy monoacrylate monomer.

8. The composition of claim 1, wherein said reaction product further comprises a diisocyanate monomer.

9. The composition of claim 8, wherein said diisocyanate monomer is selected from the group consisting of m-TMXDI, IPDI, and bis(4-isocyanato phenyl)methane.

10. The composition of claim 1, wherein said resin reaction product further comprises a monohydric acrylate monomer.

11. The composition of claim 1, wherein said reactive diluent comprises at least two ethylenically unsaturated groups.

12. The composition of claim 11, wherein said reactive diluent is selected from the group consisting of dipentaerythritol pentaacrylate, trimethylolpropane triacrylate and pentaerythritol tetraacrylate.

13. The composition of claim 11, wherein said reactive diluent comprises dipentaerythritol pentaacrylate.

14. The composition of claim 1, wherein said resin reaction product has a weight average molecular weight of at least about 8,000.

15. The composition of claim 1, wherein said resin reaction product has a weight average molecular weight of at least about 13,000.

16. A method for improving the. blocking resistance of a negative photoresist comprising using as the photoresist the composition of claim 1.

17. The method of claim 16, wherein said composition comprises a urethane acrylate resin having a weight average molecular weight of at least about 13,000.

18. The method of claim 17, wherein said resin comprises the reaction product of a polyhydric acrylate monomer and an isocyanurate of a cycloaliphatic or aromatic polyisocyanate.

19. The method of claim 18, wherein said isocyanurate is an isocyanurate of isophorone diisocyanate.

20. A method of producing a negative photoresist comprising: applying the composition of claim 1 to a substrate, exposing the substrate to actinic radiation, and developing the exposed substrate.

21. The method of claim 20, wherein said composition comprises a urethane acrylate resin having a weight average molecular weight of at least about 13,000.
